(19) United States
(12) Patent Application Publication
(10) Pub. No.: US 2022/0144512 A1
(43) Pub. Date: May 12, 2022

(54) A CABLE TIE

(71) Applicant: TIMOTHY DUDEK, ARKLES BAY (NZ)

(72) Inventor: TIMOTHY DUDEK, ARKLES BAY (NZ)

(21) Appl. No.: 17/430,128

(22) PCT Filed: Aug. 20, 2020
(86) PCT No.: PCT/NZ2020/050009

§ 371 Date: Aug. 11, 2021

(30) Foreign Application Priority Data
Feb. 11, 2019 (NZ) 750593

(51) Int. Cl. B65D 63/10

(52) U.S. Cl. CPC B65D 63/1027

(57) ABSTRACT

A cable tie having: a head and tail which releasably engage with each other; an elongated flexible strap extending between the head and the tail; a releasing means; and a locking means; the cable tie arranged such that when in use and when it has been securely fixed to a surface a user is able to move the cable tie between an open configuration, a holding configuration which holds at least one cable and a fastened configuration which fastens at least one cable, the arrangement also being such that when the cable tie is in the fastened configuration the locking means prevents it from moving into the open configuration, the releasing means also enables a user to move the cable tie from the holding or fastened configuration into an open configuration so that a user can add more cables.

### FIELD OF INVENTION

The invention generally relates to a cable tie. More particularly, but not exclusively the invention relates to a reusable cable tie.

### BACKGROUND

The differing sizes, quantity and timing of when a cable or cables are going to be installed and how the cables are going to be retained is a known problem for electricians. Typically when installing cable ties a cable tie mount is screwed into the wall after the cables have been added and the cable tie is tied. Additional cables are usually added after the cable tie has been tied which requires the cable tie to be cut before the new cables are added. Alternatively, pin clips can be used however they are hard to re-use and can only be used for the temporary not permanent holding of cables.

It is an object of a preferred form of the present invention to go at least some way towards addressing the above problem. While this is an object of a preferred embodiment, it should not be seen as a limitation on the scope of the invention as claimed. The object of the invention per se is simply to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein; this reference does not constitute an admission that any of these documents form part of the common general knowledge in the art, in New Zealand or in any other country.

The term “comprising” and derivatives thereof, eg “comprises”, if and when used herein in relation to a combination of features should not be taken as excluding the possibility that the combination may have further unspecified features. For example, a statement that an arrangement “comprises” certain parts does not mean that it cannot also, optionally, have additional parts.

### SUMMARY OF THE INVENTION

According to one aspect of the invention there provided a cable tie having:
a head which is configured such that it is capable of being fixed to a surface and is also adapted to releasably engage with a tail;
a tail which is adapted to releasably engage with the head;
an elongated flexible strap extending between the head and the tail;
a releasing means; and
a locking means;

the cable tie arranged such that when in use and when it has been securely fixed to a surface a user is able to move the cable tie between an open configuration, a holding configuration which holds at least one cable and a fastened configuration which fastens at least one cable, the arrangement also being such that when the cable tie is in the fastened configuration the locking means prevents the cable tie from moving into the open configuration, the cable tie also adapted such that the releasing means enables a user to move the cable tie from the holding or fastened configuration into an open configuration so that a user can add more cables.

Preferably the head has an aperture for receiving a fixing means (e.g. a screw or the like).

Preferably the head has a slot adapted to receive the tail and strap.

Preferably the slot is angled at a 45 degree angle in relation to the surface the cable tie is fixed too.

Preferably the slot has a guide rail on each side adapted to prevent the cable tie twisting when it is fastened.

Preferably the width of the slot is less than the width of the end of the tail so that it stops the tail being pulled backwards through the head when the tail and head are engaged.

Preferably the tail has a T-shaped member which acts to prevent the tail being pulled backwards through the slot in the head when the tail and head are engaged.

Preferably the tail also has a pair of retaining members which help retain the tail in the slot when the tail is clicked in from above the head when in use.

Preferably the locking means is a plurality of ratchet serrations on the strap and a plurality of ratchet teeth in the head which engage into a locking engagement with each other.

Preferably the tail has a tab for gripping.

Preferably the releasing means are a pair of wings which are configured to release the tail or strap from the head when they are both squeezed.

Preferably the bottom surface of the head has gripping members (e.g. diamond shaped bumps) which are adapted to dig into the surface the head is being fixed to stop movement of the head when it is being fixed to a surface.

Preferably the strap has guide rails on both sides adapted to prevent the cable tie twisting when fastened.

Preferably the head does not flex in relation to the surface it is fixed to when in use and fixed to a surface.

Preferably the cable tie is between about 150-400 mm in length.

Preferably the cable tie is about 250 mm in length.

Preferably the cable tie is made from injection moulded nylon.

Preferably the fastening position (e.g. the aperture) is inside the cable tie loop when in use and when the cable tie is in the holding or fastened configuration.

In a further aspect of the invention there is provided a method of securing cables to a surface using the previously described cable tie comprising the steps of:
fixing the cable tie to a surface with a fixing means (e.g. a screw, nail or the like etc);
looping the strap and tail around at least one cable;
engaging the tail with the head so that cables are temporarily held by the cable tie;
optionally disengaging the tail with the head via the releasing means to add more cables and then reengaging the tail with the head so that the cables are again temporarily held by the cable tie; and
fastening the cable tie by pulling the tail and strap past the head until the cables are fastened via the locking means by the cable tie.

These and other features, objects and advantages of the present invention will be readily apparent to persons of ordinary skill in the art upon reading the entirety of this disclosure, which includes the accompanying drawings and claims.

### BRIEF DESCRIPTION OF THE DRAWINGS

Some preferred embodiments of the invention will now be described by way of example and with reference to the accompanying photos and drawings, of which:

FIG. 1 is a side view of a cable tie;

FIG. 2 is a top view of the cable tie;

FIG. 3 is a bottom view of the cable tie;

FIG. 4 is a top view of a head and strap which form part of the cable tie;

FIG. 5 is a front view of the head and tail which forms part of the cable tie;

FIG. 6 is a top view of a tail and strap which form part of the cable tie;

FIG. 7 is a side view of the tail and strap which form part of the cable tie;

FIG. 8 is a perspective view of an alternative embodiment of a cable tie wherein the tail of the cable tie has been engaged in a temporary holding configuration with the head of the cable tie; and

FIG. 9 is a perspective view of an alternative embodiment of a cable tie when it is in a fastened configuration.

### DETAILED DESCRIPTION

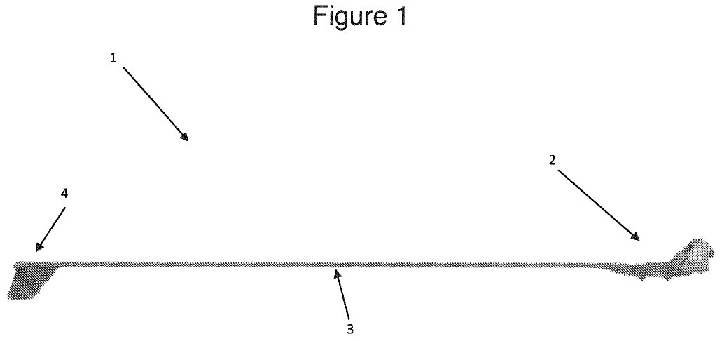

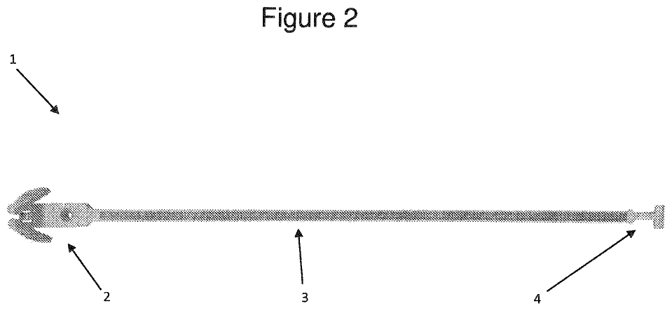

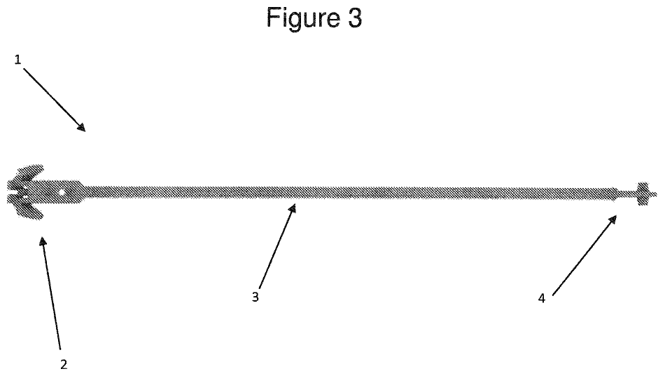

FIG. 1 shows a cable tie 1. The cable tie 1 is for tying a cable or bundle of cables or the like and securing the cable or bundle to a surface such as a wall or building panel etc. As can be seen in FIGS. 1-3 the cable tie 1 has a head 2, an elongated flexible strap 3 and a tail 4. The cable tie 1 is able to move between an open configuration (like that shown in FIGS. 1-3), a temporary holding configuration (not shown in FIGS. 1-3) and a fastened configuration (not shown in FIGS. 1-3).

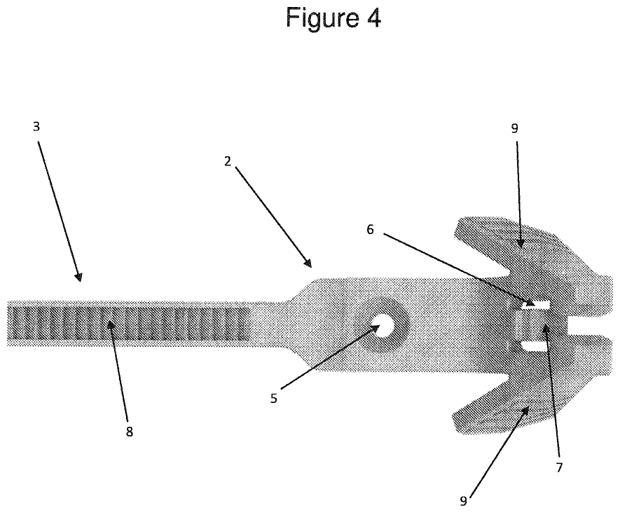

FIG. 4 shows the head 2 in more detail. As can be seen the head 2 of the cable tie 1 has an aperture 5 for receiving a fastening means such as a screw, bolt or the like (not shown) which when in use fixes the cable tie 1 to surface such as a wall, ceiling, building frame or floor etc. The head 2 does not flex in relation to the surface when it is fixed to it by a nail, screw or the like. The head 2 also has a slot 6 adapted to receive the strap 3 and tail 4. The width of the slot 6 is less than the width of the end of the tail 4 so that it stops the tail 4 being pulled backwards through the head 2 when the tail 4 and head 2 are engaged. When the head 2 and tail 4 are engaged the cable tie 1 is in a temporary holding configuration. The slot 6 is at about a 45 degree angle in relation to the surface the cable tie 1 it is fixed to so that when the head 2 has been fixed to a flat surface the tail 4 can still be pulled through the slot 6. The head 2 also has a set of teeth 7 which are adapted to engage into a locking relationship with corresponding ratchet serrations 8 which are located on the upper surface of the strap 3. The tail 4 can either be clicked into the temporary holding configuration or user can pull the tail through the slot 6 so that the teeth 7 and serrations 8 on the strap 3 are engaged which results in the cable tie being in the fastened configuration. In a most preferred embodiment when the teeth 7 and the corresponding ratchet serrations 8 when engaged they are fully engaged and parallel. In a preferred embodiment (not shown) the teeth extend further than is shown in FIG. 4. Also in some further embodiments (not shown) there is a guide rail on both sides of the slot 6 to stop of cable tie 1 from twisting when it is fastened/tightened. The tolerance between the strap 3 and guide rail is preferably 0.05 mm when the strap 3 is in fixture. The head 2 also has two wing shaped members 9 which are used for releasing the strap 3 or tail 4 when they are engaged with the head 2. In some embodiments instead of wings 9 other type of means can be used as the releasing mechanism and in alternative embodiments instead of a ratchet a different type of locking means can be used. In some embodiments (not shown) the head has an up arrow on the front face pointing towards the slot 6 to assist the user to orientate the cable tie 1 correctly.

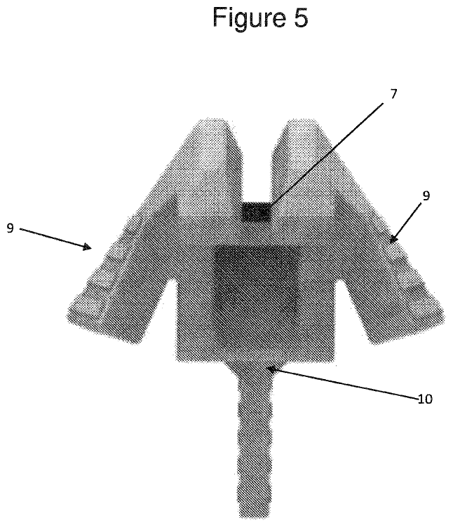

As illustrated in FIG. 5 the bottom of the head 2 also has two diamond shaped gripping members 10 (only one is visible) and these dig into the surface the cable tie 1 is being fixed with to stop the cable tie 1 from spinning on the nail, screw or other type of fastening means when it is being installed.

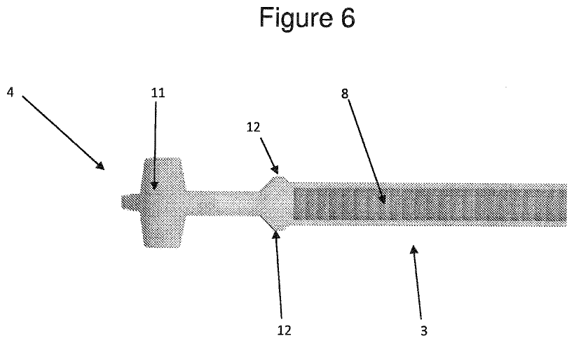

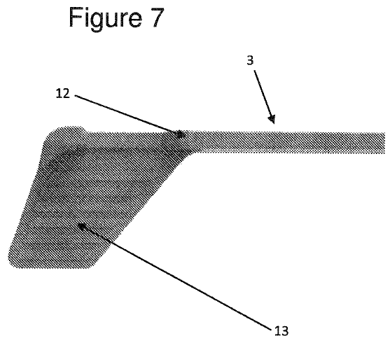

FIGS. 6 and 7 show the tail 4 in more detail. The tail 4 has a T-bar shaped member 11 which is wider than the slot 6 in the head 2 such that when the head 2 and tail 4 are engaged they are in the temporary holding configuration the T-bar member stops the head 4 being pulled back through the slot 6. The tail 4 also has a pair of retaining members 12 which help retain the tail 4 in the slot 6 when the tail is clicked in from above the head 2. The tail 4 also has a tab 13 which a user can use one hand to grip the tail 4 with. In some embodiments the cable tie 1 may have a guide bevel (not shown) on the bottom edges of the strap 3 to stop the cable tie 1 from twisting when it is tightened/fastened in use.

In use a user secures the cable tie 1 to a surface (e.g. a wall) by holding the cable tie 1 against the surface and fixing the cable 1 to the surface with a fastening means such as a screw or nail which goes through the aperture 5 in the fixing head 2 into the surface which results in the cable tie 1 being secured to the surface. The gripping members 10 dig into the surface the cable tie 1 is being fixed to stop the tie 1 from spinning on the nail, screw or other type of fastening means when it is being installed. After the cable tie 1 has been fixed to the surface the user then starts feeding or passing a cable or cables past the tie 1 and then grabs the tail 4 via the tab 13 and loops the tail 4 and strap 3 around the cable or cables and brings the tail 4 to the head 2 of the tie 1 and clicks the tail 4 downwardly into the slot 6 in the head 2 which results in the cable being held by in the temporary holding configuration. The user can then add additional cables by pulling the tail 4 out upwardly from the head 2. Once the additional cables are added the user can click the tail 4 back downwardly into the head 2 so that the cable tie 1 is back in the temporary holding configuration. Once a user has finished adding cables the tab 13 of the tail 4 is gripped and the strap 3 is pulled through the slot 6 in the head 2 until a desired tightness is achieved and the teeth 7 and serrations 8 are engaged so that the cable tie 1 is in the fastened configuration. Once the cable tie 1 is in the fastened configuration it still has the ability to be released (i.e. by squeezing the wings 9) to add extra cables without the use of a tool.

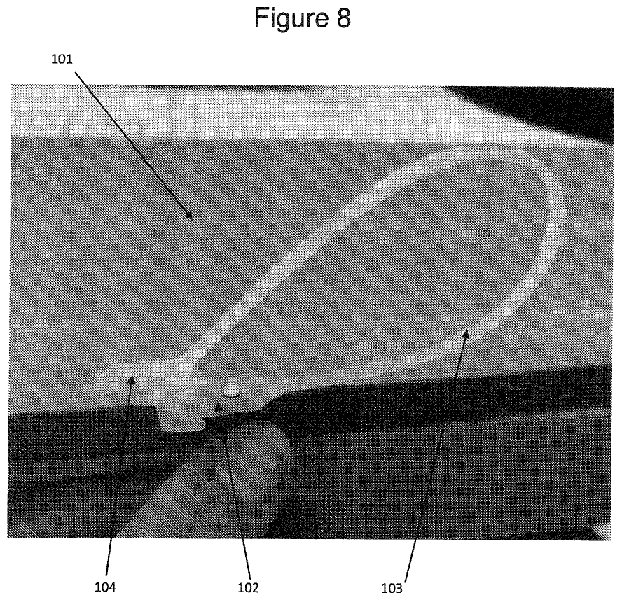

FIG. 8 shows an alternative embodiment of a cable tie 101. As shown the head 102 which is attached to the strap 103 and tail 104 which is also attached to the strap 103 are engaged and are in a temporary holding configuration.

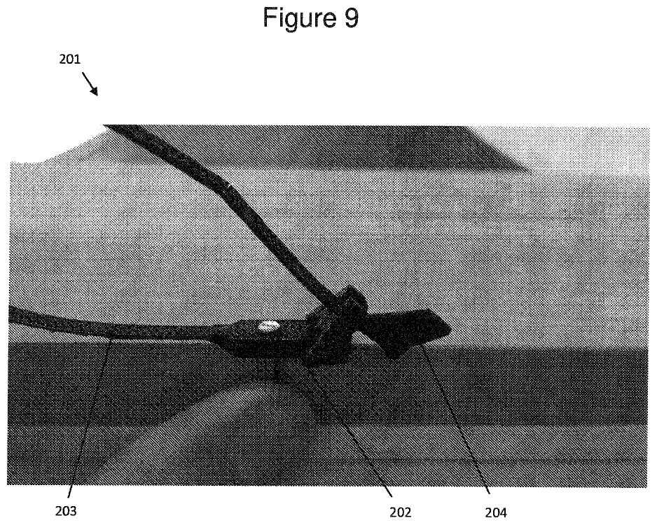

FIG. 9 shows a further embodiment of a cable tie 201. As shown the tail 204 has been clipped into the head 202 and pulled through along with the strap 203 to the start of a fastened configuration.

The cable tie 1, 101, 201 is preferably a one-piece cable tie 1, 101, 201 and made from injection moulded nylon however those skilled in the art will appreciate that the cable tie 1, 101, 201 can be made from any other suitable material and ways and does not need to be a one-piece cable tie 1. Those skilled in the art will appreciate that the cable tie 1, 101, 201 and its parts (e.g. head 2, 102, 202, strap 3, 103, 203 and tail 4, 104, 204) can be made in variety of sizes however the cable tie 1, 101, 201 is preferably between about 150 mm and 400 mm in length and most preferably about 250 mm in length.

The cable tie 1, 101, 201 has a number of advantages and benefits over known cable ties or ways to secure cables. The cable tie 1, 101, 201 is reusable and the cable tie 1, 101, 201 has the ability to be released such that extra cables can be added without the use of a tool. Furthermore, the fixing position is located inside the cable tie loop as is not the case with some known cable ties which limits their use. As the cable tie 1, 101, 201 allows a user to add more cables and work on more cabling this means that cables are not having to be cut and wasted. Additionally as the head 2, 102, 202 is not flexible in relation to the fixing means (e.g. screw) once the head is fixed to the surface this holds the head 2, 102, 202 securely which means a user can use one hand for cables and the other to operate the temporary holding and releasing mechanism.

It is to be understood that even though numerous characteristics and advantages of the various embodiments of the present invention have been set forth in the foregoing description, together with details of the structure and functioning of various embodiments of the invention, this disclosure is illustrative only, and changes may be made in detail so long as the functioning of the invention is not adversely affected. For example, the particular elements of the cable tie 1, 101, 201 such as the head 2, 102, 202, strap 3, 103, 203 and tail 4, 104, 204 may vary dependent on the particular application for which it is used without variation in the spirit and scope of the present invention. In addition, although the preferred embodiments described herein are directed to a cable tie it will be appreciated by those skilled in the art that variations and modifications can be made within the scope of the appended claims.

1. A cable tie having:
a head which is configured such that it is capable of being fixed to a surface and is also adapted to releasably engage with a tail;
a tail which is adapted to releasably engage with the head;
an elongated flexible strap extending between the head and the tail;
a releasing means; and
a locking means;
the cable tie arranged such that when in use and when it has been securely fixed to a surface a user is able to move the cable tie between an open configuration, a holding configuration which holds at least one cable and a fastened configuration which fastens at least one cable, the arrangement also being such that when the cable tie is in the fastened configuration the locking means prevents the cable tie from moving into the open configuration, the cable tie also adapted such that the releasing means enables a user to move the cable tie from the holding or fastened configuration into an open configuration so that a user can add more cables.

2. A cable tie according to claim 1, wherein the head has an aperture for receiving a fixing means.

3. A cable tie according to claim 1, wherein the head has an aperture for receiving a fixing means and wherein the aperture is inside a cable tie loop when the cable tie is in the holding or fastened configuration

4. A cable tie according to claim 1 wherein the head has a slot adapted to receive the tail and strap.

5. A cable tie according to claim 1, wherein the head has a slot adapted to receive the tail and strap and wherein in use the slot is angled at a 45 degree angle in relation to the surface the cable tie is fixed too.

6. A cable e according to claim 1, wherein the head has a slot adapted to receive the tail and strap and wherein the slot has a guide rail on each side adapted to prevent the cable tie twisting when it is fastened.

7. A cable tie according to claim 1, wherein the head has a slot adapted to receive the tail and strap and wherein the width of the slot is less than the width of the end of the tail so that it stops the tail being pulled backwards through the head when the tail and head are engaged.

8. A cable tie according to claim 1, wherein the head has a slot adapted to receive the tail and strap and wherein the tail has a T-shaped member which acts to prevent the tail being pulled backwards through the slot in the head when the tail and head are engaged

9. A cable tie according to claim 1, wherein the head has a slot adapted to receive the tail and strap and wherein the tail has a pair of retaining members which help retain the tail in the slot when the tail is clicked in from above the head when in use.

10. A cable tie according to claim 1, wherein the locking means is a plurality of ratchet serrations on the strap and a plurality of ratchet teeth in the head which engage into a locking engagement with each other when in use.

11. A cable tie according to claim 1, wherein the tail has a tab for gripping.

12. A cable tie according to claim 1, wherein the releasing means are a pair of wings which are configured to release the tail or strap from the head when they are both squeezed.

13. A cable tie according to claim 1, wherein the bottom surface of the head has gripping members which are adapted to dig into the surface the head is being fixed to stop movement of the head when it is being fixed to a surface.

14. A cable tie according to claim 1, wherein the strap has guide rails on both sides adapted to prevent the cable tie twisting when fastened.

15. A cable tie according to claim 1, wherein the head does not flex in relation to the surface it is fixed to when in use and fixed to a surface.

16. A cable tie according to claim 1, wherein the cable tie is between about 150 mm to about 400 mm in length.

17. A cable tie according to claim 1, wherein the cable is about 250 mm in length.

18. A cable tie according to claim 1, wherein the cable tie is made from injection moulded nylon.
